(19) United States
(12) Patent Application Publication
(10) Pub. No.: US 2026/0291548 A1
(43) Pub. Date: Sep. 24, 2026

(54) ACCESS POINT OF MULTI-ACCESS-POINT SYSTEM THAT EMPLOYS PREAMBLE COLLISION REDUCTION TECHNIQUE FOR COORDINATED BEAMFORMING IN DOWNLINK PACKET TRANSMISSION

(71) Applicant: MEDIATEK INC., Hsin-Chu (TW)

(72) Inventors: Hung-Tao Hsieh, Hsinchu City (TW); Shengquan Hu, San Jose, CA (US); Chien-Fang Hsu, Hsinchu City (TW); Shuling Feng, San Jose, CA (US); Jianhan Liu, San Jose, CA (US)

(73) Assignee: MEDIATEK INC., Hsin-Chu (TW)

(21) Appl. No.: 19/479,359

(22) PCT Filed: Jun. 18, 2024
(86) PCT No.: PCT/CN2024/099815

§ 371 Date: Oct. 28, 2025

Related U.S. Application Data
(60) Provisional application No. 63/509,037, filed on Jun. 20, 2023.

(51) Int. Cl. H04B 7/024; H04L 5/00; H04L 27/26

(52) U.S. Cl. CPC H04B 7/024; H04L 5/0048; H04L 27/2602

(57) ABSTRACT

A first access point (AP) of a multi-AP (MAP) system includes a network interface circuit and a control circuit. The control circuit generates a first coordinated beamforming (CBF) physical layer protocol data unit (PPDU) with a precoded preamble part and an un-precoded preamble part, and instructs the network interface circuit to transmit the first CBF PPDU after at least one non-AP station (STA) associated to the first AP and at least one non-AP STA associated to at least one second AP of the MAP system are informed of synchronized preamble signal (SIG) contents.

### BACKGROUND OF THE INVENTION

### 1. Field of the Invention

The present invention relates to wireless communications, and more particularly, to an access point (AP) of a multi-AP (MAP) system that employs a preamble collision reduction technique for coordinated beamforming (CBF) in downlink packet transmission.

### 2. Description of the Prior Art

With development of the Wi-Fi technology, an MAP system is proposed. In the MAP system, there are multiple APs (e.g., AP multilink devices (MLDs)) coordinated to serve non-AP stations (STAs) (e.g., non-AP MLDs). With the ever-growing of mobile users, co-channel interference becomes unbearable in dense wireless networks. Collaboration between adjacent APs is a promising approach to improve the utilization of limited radio resources. The APs may be densely deployed and equipped with multiple antennas. Hence, coordinated beamforming (CBF) may be employed to decrease packet decoding failure resulting from collisions at co-channel APs. For example, CBF may be implemented by using a digital precoding/filtering technique to eliminate interference between adjacent APs. Each packet, also called a physical layer protocol data unit (PPDU), contains preamble and data fields. Taking a WiFi-7 PPDU as an example, it may include Non-HT Short Training field (L-STF), Non-HT Long Training field (L-LTF), Non-HT Signal field (L-SIG), Repeated Non-HT Signal field (RL-SIG), Universal Signal field (U-SIG), EHT Signal field (EHT-SIG), EHT Short Training field (EHT-STF), EHT Long Training field (EHT-LTF), Data field (EHT-Data), and Packet Extension field (PE). Taking a Wi-Fi 6 PPDU as an example, it may include L-STF, L-LTF, L-SIG, RL-SIG, HE Signal A field (HE-SIG-A), HE Signal B field (HE-SIG-B), HE Short Training field (HE-STF), HE Long Training field (HE-LTF), Data field (HE-Data), and PE. The precoding (i.e., digital beamforming) can be used to eliminate interference after EHT-STF/HE-STF. In other words, a preamble of a Wi-Fi packet includes an un-precoded preamble part and a precoded preamble part, where the un-precoded preamble part may start from L-STF, and the precoded preamble part may start from EHT-STF/HE-STF. The un-precoded preamble part which carries certain signal (SIG) contents, including Modulation and Coding Scheme (MCS), resource unit (RU) allocation, etc., is subject to interference from other APs. Thus, there is a need for an innovative design that is capable of cancelling/mitigating preamble collision of CBF PPDUs transmitted by APs in the same MAP system.

### SUMMARY OF THE INVENTION

One of the objectives of the claimed invention is to provide an access point (AP) of a multi-AP (MAP) system that employs a preamble collision reduction technique for coordinated beamforming (CBF) in downlink packet transmission.

According to a first aspect of the present invention, an exemplary first AP of an MAP system includes a network interface circuit and a control circuit. The control circuit is arranged to generate a first CBF physical layer protocol data unit (PPDU) with a precoded preamble part and an un-precoded preamble part, and instruct the network interface circuit to transmit the first CBF PPDU after at least one non-AP station (STA) associated to the first AP and at least one non-AP STA associated to at least one second AP of the MAP system are informed of synchronized preamble signal (SIG) contents.

According to a second aspect of the present invention, an exemplary first AP of an MAP system includes a network interface circuit and a control circuit. The control circuit is arranged to generate a first CBF PPDU with a precoded preamble part and an un-precoded preamble part, and instruct the network interface circuit to transmit the first CBF PPDU, wherein a preamble SIG content is carried by the precoded preamble part.

According to a third aspect of the present invention, an exemplary first AP of an MAP system includes a network interface circuit and a control circuit. The control circuit is arranged to generate a first CBF PPDU with a precoded preamble part and an un-precoded preamble part, and instruct the network interface circuit to transmit the first CBF PPDU after synchronized preamble SIG contents are confirmed by the first AP and at least one second AP of the MAP system, wherein the same synchronized SIG contents are carried by each of the un-precoded part of the first CBF PPDU and an un-precoded part of a second CBF PPDU transmitted by the at least one second AP.

According to a fourth aspect of the present invention, an exemplary first AP of an MAP system includes a network interface circuit and a control circuit. The control circuit is arranged to generate a first CBF PPDU with a precoded preamble part and without an un-precoded preamble part, and instruct the network interface circuit to transmit the first CBF PPDU.

According to a fifth aspect of the present invention, an exemplary first AP of an MAP system includes a network interface circuit and a control circuit. The control circuit is arranged to generate a first CBF PPDU with a precoded preamble part and an un-precoded preamble part, and instruct the network interface circuit to transmit the first CBF PPDU, wherein a timing error between a starting time of the first CBF PPDU transmitted by the first AP and a starting time of a second CBF PPDU transmitted by a second AP of the MAP system is beyond a pre-defined timing error tolerance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an MAP system that supports the proposed preamble collision reduction scheme according to an embodiment of the present invention.

FIG. 2 is a diagram illustrating a CBF topology under an SU scenario according to an embodiment of the present invention.

FIG. 3 is a diagram illustrating a MAC frame exchange sequence under an SU scenario according to an embodiment.

FIG. 4 is a diagram illustrating a first PHY design for CFB PPDU transmission with the timing error dT within +/−0.4 us according to an embodiment of the present invention.

FIG. 5 is a diagram illustrating a second PHY design for CFB PPDU transmission with the timing error dT within +/−0.4 us according to an embodiment of the present invention.

FIG. 6 is a diagram illustrating a third PHY design for CFB PPDU transmission with the timing error dT within +/−0.4 us according to an embodiment of the present invention.

FIG. 7 is a diagram illustrating a fourth PHY design for CFB PPDU transmission with the timing error dT within +/−0.4 us according to an embodiment of the present invention.

FIG. 8 is a diagram illustrating a first PHY design for CFB PPDU transmission with the timing error dT beyond +/−0.4 us according to an embodiment of the present invention.

FIG. 9 is a diagram illustrating a second PHY design for CFB PPDU transmission with the timing error dT beyond +/−0.4 us according to an embodiment of the present invention.

FIG. 10 is a diagram illustrating a CBF topology under an MU scenario according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

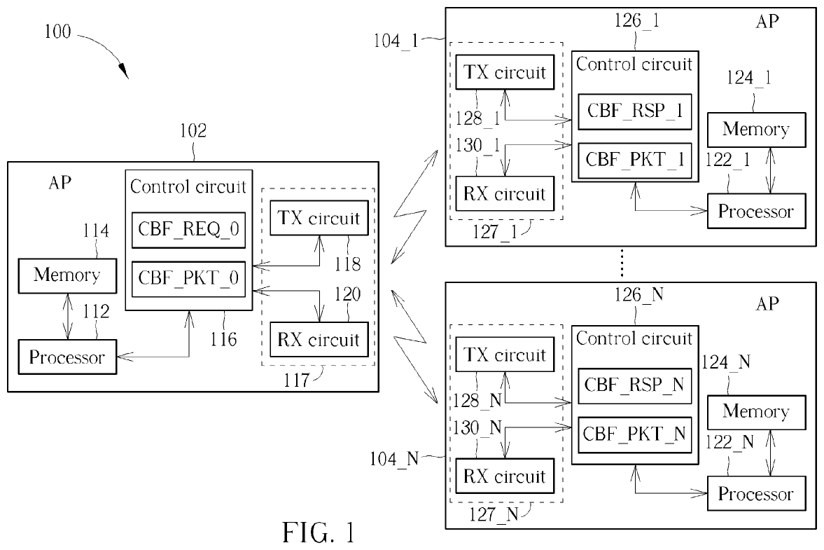

FIG. 1 is a diagram illustrating an MAP system that supports the proposed preamble collision reduction scheme according to an embodiment of the present invention. The MAP system 100 may be a Wi-Fi system compliant with IEEE 802.11ax (Wi-Fi 6) standard, IEEE 802.11be (Wi-Fi 7) standard, IEEE 802.11bn (Wi-Fi 8) standard, or a next-generation Wi-Fi standard. The MAP system 100 includes a plurality of APs 102, 104_1-104_N (N≥1). For example, the AP 102 may act as a sharing AP that shares its transmission opportunity (TXOP) with other AP(s), and each of the APs 104_1-104_N may act as a shared AP that shares the TXOP owned by the sharing AP.

It should be noted that an AP of the MAP system 100 may be an AP MLD which owns multiple links working on different RF bands and capable of operating at the same time, or may be a non-MLD AP. Hence, the MAP system 100 that supports the proposed preamble collision reduction scheme may be formed by multiple AP MLDs, multiple non-MLD APs, or a combination thereof.

The APs 102, 104_1-104_N may have the same or similar circuit structure. As shown in FIG. 1, the AP 102/104_1/104_N includes a processor 112/122_1/122_N, a memory 114/124_1/124_N, a control circuit 116/126_1/126_N, and a network interface circuit 117/127_1/127_N, where the network interface circuit 117/127_1/127_N includes a transmitter (TX) circuit 118/128_1/128_N and a receiver (RX) circuit 120/130_1/130_N. The memory 114/124_1/124_N is arranged to store a program code. The processor 112/122_1/122_N is arranged to load and execute the program code to manage the AP 102/104_1/104_N. The control circuit 116/126_1/126_N is arranged to control communications with non-AP STAs and other APs. For example, the control circuit 116/126_1/126_N controls the TX circuit 118/128_1/128_N of the network interface circuit 117/127_1/127_N to send packets (i.e., PPDUs) to non-AP STAs and other APs, and controls the RX circuit 120/122_1/122_N of the network interface circuit 117/127_1/127_N to receive packets (i.e., PPDUs) from non-AP STAs and other APs. It should be noted that the terms “packet” and “PPDU” may be interchangeable.

It should be noted that only the components pertinent to the present invention are illustrated in FIG. 1. In practice, each of APs 102, 104_1-104_N may include additional components to achieve designated functions.

The APs 102, 104_1-104_N in the same MAP system 100 supports the proposed preamble collision reduction scheme. During a MAC frame exchange sequence, the control circuit 116 of the AP (e.g., sharing AP) 102 is arranged to generate a MAC frame, also called a MAC protocol data unit (MPDU), that acts as a CBF request frame CBF_REQ_0 used to carry CBF related information, and instruct the network interface circuit 117 (particularly, TX circuit 118 of network interface circuit 117) to transmit the CBF request frame CBF_REQ_0 to at least one of APs (e.g., shared APs) 104_1-104_N of the MAP system 100 before CBF PPDU transmission of sharing AP and shared AP(s). It should be noted that the terms “MAC frame” and “MPDU” may be interchangeable.

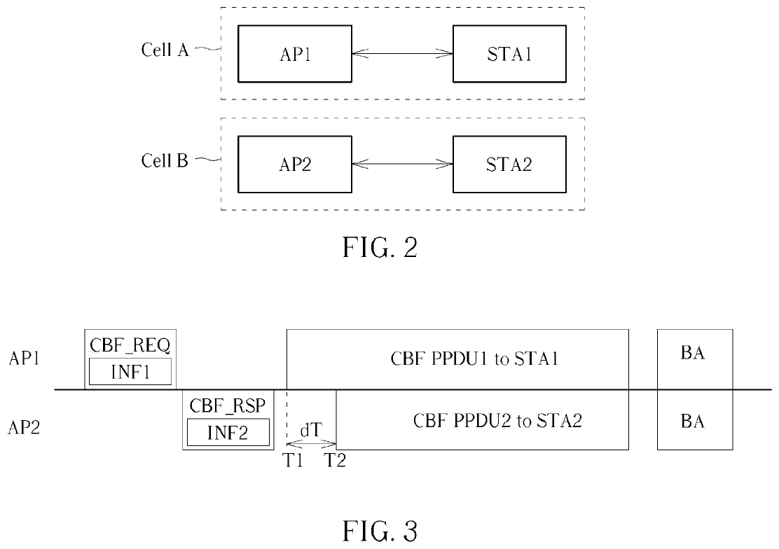

During the MAC frame exchange sequence, the control circuit 126_1/126_N of the AP (e.g., shared AP) 104_1/104_N is arranged to generate a MAC frame that acts as a CBF response frame CBF_RSP_1/CBF_RSP_N used to carry CBF related information, and instruct the network interface circuit 127_1/127_N (particularly, TX circuit 128_1/128_N of network interface circuit 127_1/127_N) to transmit the CBF response frame CBF_RSP_1/CBF_RSP_N to the AP (e.g., sharing AP) 102 before CBF PPDU transmission of sharing AP and shared AP(s). The proposed preamble collision reduction scheme may be used under a single-user (SU) scenario or a multi-user (MU) scenario. FIG. 2 is a diagram illustrating a CBF topology under an SU scenario according to an embodiment of the present invention. One non-AP STA (labeled by “STA1”) is associated to one AP (labeled by “AP1”) of one cell (labeled by “Cell A”), and another non-AP STA (labeled by “STA2”) is associated to another AP (labeled by “AP2”) of another cell (labeled by “Cell B”). In this embodiment, the AP (AP1) transmits an SU PPDU to a single non-AP STA (STA1), and the AP (AP2) transmits an SU PPDU to a single non-AP STA (STA2).

FIG. 3 is a diagram illustrating a MAC frame exchange sequence under an SU scenario according to an embodiment. One AP (AP1) may be a sharing AP, and another AP (AP2) may be a shared AP. Hence, the sharing AP (AP1) generates a CBF request frame CBF_REQ (which is a MAC frame that carries CBF related information INF1), and unicasts the CBF request frame CBF_REQ to the shared AP (AP2). In response to receiving the CBF request frame CBF_REQ, the shared AP (AP2) generates a CBF response frame CBF_RSP (which is a MAC frame that carries CBF related information INF2), and transmits the CBF response frame CBF_RSP to the sharing AP (AP1). During the CBF PPDU transmission, the sharing AP (AP1) transmits a CBF PPDU (labeled by “CBF PPDU1”) to its target non-AP STA (STA1), and receives a block acknowledgement (BA) frame from the target non-AP STA (STA1), and the shared AP (AP2) transmits a CBF PPDU (labeled by “CBF PPDU2”) to its target non-AP STA (STA2), and receives a BA frame from the target non-AP STA (STA2). With the help of the proposed MAC frame exchange sequence initiated by sharing AP (AP1), preamble collision of the follow-up CBF PPDU transmission of sharing AP (AP1) and shared AP (AP2) can be avoided or mitigated. For example, the sharing AP (AP1) may be the AP 102 shown in FIG. 1, and the shared AP (AP2) may be one of the APs 104_1-104_N shown in FIG. 1.

As mentioned above, CBF related information INF1 is carried by the CBF request frame CBF_REQ (e.g., CBF_REQ_0). In some embodiments, the sharing AP (AP1) transmits the CBF request frame CBF_REQ for controlling a starting time T2 of a CBF PPDU (labeled by “CBF PPDU2”) to be transmitted from the shared AP (AP2) to its target non-AP STA (STA2). For example, the CBF related information INF1 carried by the CBF request frame CBF_REQ may be indicative of the starting time T2 of the CBF PPDU (labeled by “CBF PPDU2”) to be transmitted from the shared AP (AP2) to its target non-AP STA (STA2). For another example, the CBF PPDU (labeled by “CBF PPDU2”) should be transmitted after Short Interframe Space (SIFS) of one PPDU carrying the CBF response frame CBF_RSP (e.g., CBF_RSP=CBF_RSP_1 or CBF_RSP_N). Since the CBF response frame CBF_RSP is generated in response to the CBF request frame CBF_REQ, the starting time T2 of AP2's CBF PPDU (labeled by “CBF PPDU2”) depends on transmission timing of the CBF request frame CBF_REQ sent from the sharing AP (AP1). In other words, the shared AP (AP2) is informed of the starting time T2 of AP2's CBF PPDU (labeled by “CBF PPDU2”) upon reception of the CBF request frame CBF_REQ.

In some embodiments of the present invention, the CBF related information INF1 carried by the CBF request frame CBF_REQ may be indicative of synchronized preamble signal (SIG) contents that are decided by the sharing AP (AP1). For certain preamble collision reduction methods that require Non-HT part content synchronization, the synchronized preamble SIG contents may be the same SIG contents to be transmitted by Non-HT parts of different APs' CBF PPDUs to ensure each CBF PPSU has the same Non-HT part. For example, the CBF related information INF1 may directly carry required SIG contents. For another example, the CBF related information INF1 may carry a simple predefined indication rather than the required SIG contents, where the simple predefined indication may indicate to select the required SIG contents from pre-defined SIG content candidates. The shared AP (AP2) is informed of the synchronized preamble SIG contents indicated by the CBF request frame CBF_REQ.

Alternatively, the CBF request frame CBF_REQ may also serve as a SIG content carrier for non-AP STAs associated to the sharing AP (AP1) and the shared AP (AP2). Specifically, the CBF request frame CBF_REQ (which carries the CBF related information INF1 indicative of synchronized preamble SIG contents) is transmit to the shared AP (AP2) as well as the target non-AP STAs (STA1 and STA2) of sharing AP (AP1) and the shared AP (AP2). In this way, the non-AP STAs (STA1 and STA2) are also informed of the same synchronized preamble SIG contents decided by the sharing AP (AP1).

In some embodiments of the present invention, the CBF related information INF1 carried by the CBF request frame CBF_REQ may be indicative of an allowed bandwidth of a CBF PPDU to be transmitted from the shared AP (AP2) to its target non-AP STA (STA2), if partial bandwidth can be used.

In some embodiments of the present invention, the CBF related information INF1 carried by the CBF request frame CBF_REQ may be indicative an identifier (ID) of the target non-AP STA (STA1) of the sharing AP (AP1), where the ID of the non-AP STA (STA1) may be referenced for setting a precoder included in a control circuit of the shared AP (AP2). For example, the ID of the non-AP STA (STA1) may be an association ID (AID) or a universal ID in the MAP system 100.

In some embodiments of the present invention, the CBF related information INF1 carried by the CBF request frame CBF_REQ may be indicative of one or more preferred non-AP STA candidates associated to the shared AP (AP2). For example, the CBF related information INF1 may include a list consisting of multiple STAs' AIDs or other IDs, and the shared AP (AP2) picks up one of the STAs on the list as the target non-AP STA (STA2) to which AP2's CBF PPDU (labeled by “CBF PPDU2”) should be sent.

In some embodiments of the present invention, the CBF related information INF1 carried by the CBF request frame CBF_REQ may be indicative of a length of a CBF PPDU (which is labeled by “CBF PPDU1”) to be transmitted from the sharing AP (AP1) to its target non-AP STA (STA1), or an ending time of the CBF PPDU (which is labeled by “CBF PPDU1”) to be transmitted from the sharing AP (AP1) to its target non-AP STA (STA1).

In some embodiments of the present invention, the CBF related information INF1 carried by the CBF request frame CBF_REQ may be indicative of a beam change setting (i.e., a value of a beam change field) included in a CBF PPDU (which is labeled by “CBF PPDU1”) to be transmitted from the sharing AP (AP1) to its target non-AP STA (STA1). When a beam change field is set by “1”, it implies that a preamble of the CBF PPDU (which is labeled by “CBF PPDU1”) includes an un-precoded preamble part and a precoded preamble part. For example, the un-precoded preamble part starts from L-STF, and the precoded preamble part starts from EHT-STF/HE-STF. When the beam change field is set by “0”, it implies that the whole preamble of the CBF PPDU (which is labeled by “CBF PPDU1”) is precoded. That is, the sharing AP (AP1) transmits the CBF PPDU (which is labeled by “CBF PPDU1”) with a precoded preamble part and without an un-precoded preamble part.

As mentioned above, CBF related information INF2 is carried by the CBF response frame CBF_RSP (e.g., CBF_RSP_1 or CBF_RSP_N) that is generated in response to the CBF request frame CBF REQ (e.g., CBF_REQ_0). In some embodiments of the present invention, the CBF related information INF2 set by the shared AP (AP2) may be indicative of whether a CBF request of the sharing AP (AP1) is rejected or accepted.

In some embodiments of the present invention, the CBF related information INF2 carried by the CBF response frame CBF_RSP may be indicative of synchronized preamble signal (SIG) contents that are decided by the shared AP (AP2). For example, the CBF related information INF2 may directly carry required SIG contents. For another example, the CBF related information INF2 may carry a simple predefined indication rather than the required SIG contents, where the simple predefined indication may indicate to select the required SIG contents from pre-defined SIG content candidates. In a case where the CBF related information INF1 carried by the CBF request frame CBF_REQ indicates synchronized preamble SIG contents that are set by the sharing AP (AP1) and the shared AP (AP2) does not accept all of the synchronized preamble SIG contents proposed by the sharing AP (AP1), the shared AP (AP2) can inform the sharing AP (AP1) of its preferred synchronized preamble SIG contents through the CBF related information INF2 carried by the CBF response frame CBF_RSP, such that the same synchronized preamble SIG contents can be used by both of the sharing AP (AP1) and the shared AP (AP2) during CBF PPDU transmission. In another case where the CBF related information INF1 carried by the CBF request frame CBF_REQ does not indicate synchronized preamble SIG contents, the shared AP (AP2) can inform the sharing AP (AP1) of synchronized preamble SIG contents through the CBF related information INF2 carried by the CBF response frame CBF_RSP, such that the same synchronized preamble SIG contents can be used by both of the sharing AP (AP1) and the shared AP (AP2) during CBF PPDU transmission.

The sharing AP (AP1) is informed of the synchronized preamble SIG contents indicated by the CBF response frame CBF_RSP, and adopts the synchronized preamble SIG contents decided by the shared AP (AP2). Alternatively, the CBF response frame CBF_RSP may also serve as a SIG content carrier for target non-AP STAs (STA1 and STA2) of sharing AP (AP1) and shared AP (AP2). Specifically, the CBF response frame CBF_RSP (which carries the CBF related information INF2 indicative of synchronized preamble SIG contents) is encapsulated in a PPDU with an MU PPDU format, and is transmit to the sharing AP (AP2) as well as the non-AP STAs (STA1 and STA2). In this way, the non-AP STAs (STA1 and STA2) are also informed of the same synchronized preamble SIG contents decided by the shared AP (AP2).

In some embodiments of the present invention, the CBF related information INF2 carried by the CBF response frame CBF_RSP may be indicative of a bandwidth of a CBF PPDU (labeled by CBF PPDU2) to be transmitted from the shared AP (AP2) to its target non-AP STA (STA2), if partial bandwidth can be used. Compared to the allowed bandwidth indicated by the CBF related information INF1 included in the CBF request frame CBF_REQ, a narrower bandwidth can be indicated by the CBF related information INF2 included in the CBF response frame CBF_RSP.

In some embodiments of the present invention, the CBF related information INF2 carried by the CBF response frame CBF_RSP may be indicative an ID of the target non-AP STA (STA2) of the shared AP (AP2), where the ID of the non-AP STA (STA2) may be referenced for setting a precoder included in a control circuit of the sharing AP (AP1). For example, the ID of the non-AP STA (STA2) may be an AID or a universal ID in the MAP system 100. It should be noted that the non-AP STA (STA2) cannot enter a power save (PS) mode if its AID is indicated by the CBF related information INF2 of the CBF response frame CBF_RSP.

After receiving the CBF request frame CBF_REQ sent from the sharing AP (AP1), the shared AP (AP2) needs to parse information included in the CBF request frame CBF_REQ. Similarly, after receiving the CBF response frame CBF_RSP sent from the shared AP (AP2), the sharing AP (AP1) needs to parse information included in the CBF response frame CBF_RSP. In some embodiments of the present invention, necessary padding may be added to the CBF request frame CBF_REQ to allow processing latency at the shared AP (AP2), and/or necessary padding may be added to the CBF response frame CBF_RSP to allow processing latency at the sharing AP (AP1).

The preceding MAC frame exchange sequence can provide useful information to facilitate preamble collision reduction of the following CBF PPDU transmission. After the control circuit 116 of the AP (e.g., sharing AP) 102 obtains the CBF response frame CBF_RSP_1/CBF_RSP_N via the network interface circuit 117 (particularly, RX circuit 120 of network interface circuit 117) and the control circuit 126_1/126_N of the AP (e.g., shared AP) 104_1/104_N obtains the CBF request frame CBF_REQ_0 via the network interface circuit 127_1/127_N (particularly, RX circuit 130_1/130_N of network interface circuit 127_1/127_N), the AP (e.g., sharing AP) 102 and the AP (e.g., shared AP) 104_1/104_N start CBF PPDU transmission. The control circuit 116 of the AP (e.g., sharing AP) 102 generates a CBF PPDU (i.e., TX packet) CBF_PKT_0, and instructs the network interface circuit 117 (particularly, TX circuit 118 of network interface circuit 117) to transmit the CBF PPDU (i.e., TX packet) CBF_PKT_0 to a target non-AP STA associated to the AP (e.g., sharing AP) 102 under an SU scenario. Similarly, the control circuit 126_1/126_N of the AP (e.g., shared AP) 104_1/104_N generates a CBF PPDU (i.e., TX packet) CBF_PKT_1/CBF_PKT_N, and instructs the network interface circuit 127_1/127_N (particularly, TX circuit 128_1/128_N of network interface circuit 127_1/127_N) to transmit the CBF PPDU (i.e., TX packet) CBF_PKT_1/CBF_PKT_N to a target non-AP STA associated to the AP (e.g., shared AP) 104_1/104_N under an SU scenario.

In some embodiments of the present invention, transmission of sharing AP's CBF PPDU and transmission of shared AP's CBF PPDU may be synchronous, such that a timing error between a starting time of a CBF PPDU transmitted by the sharing AP and a starting time of a CBF PPDU transmitted by the shared AP is within a pre-defined timing error tolerance such as +/−0.4 us as specified in the Wi-Fi specification. As shown in FIG. 3, synchronous transmission of API's CBF PPDU (labeled by “CBF PPDU1”) and AP2's CBF PPDU (labeled by “CBF PPDU2”) happens under a condition that the timing error dT is within the pre-defined timing error tolerance.

In some embodiments of the present invention, transmission of sharing AP's CBF PPDU and transmission of shared AP's CBF PPDU may be asynchronous, such that a timing error between a starting time of a CBF PPDU transmitted by the sharing AP and a starting time of a CBF PPDU transmitted by the shared AP is beyond a pre-defined timing error tolerance such as +/−0.4 us as specified in the Wi-Fi specification. As shown in FIG. 3, asynchronous transmission of API's CBF PPDU (labeled by “CBF PPDU1”) and AP2's CBF PPDU (labeled by “CBF PPDU2”) happens under a condition that the timing error dT is beyond the pre-defined timing error tolerance.

Based on whether the timing error dT is larger or smaller than the pre-defined timing error tolerance, the present invention proposes several PHY designs directed to preamble collision reduction of CFB PPDU transmission. Regarding PHY designs proposed for preamble collision reduction of CFB PPDU transmission, preamble alignment may be 80 MHz based, the PPDU may be an aggregated PPDU (A-PPDU), and/or different APs may have different bandwidth. However, these are for illustrative purposes only, and are not meant to be limitations of the present invention.

For better comprehension of technical features of the proposed PHY designs, the following assumes that the CBF topology shown in FIG. 2 is employed. Hence, one non-AP STA (STA1) is associated to one sharing AP (AP1) under the SU scenario, and another non-AP STA (STA2) is associated to the shared AP (AP2) under the SU scenario. For example, the sharing AP (AP1) may be the AP 102 shown in FIG. 1, and the shared AP (AP2) may be one of the APs 104_1-104_N shown in FIG. 1.

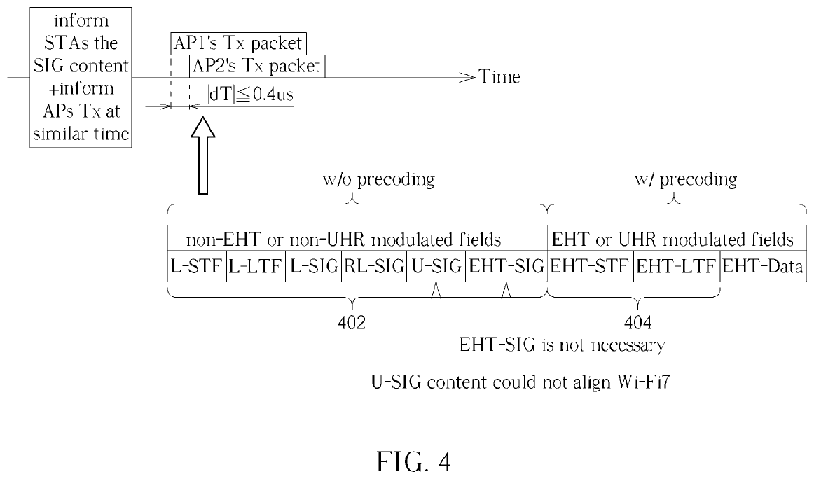

FIG. 4 is a diagram illustrating a first PHY design for CFB PPDU transmission with the timing error dT within +/−0.4 us according to an embodiment of the present invention. The non-AP STAs (STA1 and STA2) are informed of same synchronized preamble SIG contents during the MAC frame exchange sequence. In addition, CBF PPDU timing synchronization is achieved through a CBF request frame (e.g., CBF_REQ_0) that is generated from the sharing AP (AP1) and controls a starting time of the CBF PPDU (e.g., CBF_PKT_1/CBF_PKT_N) generated from the shared AP (AP2). For example, the CBF PPDU (e.g., CBF_PKT_1/CBF_PKT_N) should be transmitted after SIFS of a PPDU carrying the CBF response frame (e.g., CBF_RSP_1/CBF_RSP_N) that is generated in response to the CBF request frame (e.g., CBF_REQ_0). In this embodiment, the CBF PPDU (e.g., CBF_PKT_0) generated from the sharing AP (AP1) has a precoded preamble part 404 and an un-precoded preamble part 402. Similarly, the CBF PPDU (e.g., CBF_PKT_1/CBF_PKT_N) generated from the shared AP (AP2) also has a precoded preamble part 404 and an un-precoded preamble part 402. Since the synchronized preamble SIG contents are provided to the non-AP STAs (STA1 and STA2) before the CBF PPDU transmission is initiated, the preamble collision between API's CBF PPDU (e.g., CBF_PKT_0) and AP2's CBF PPDU (e.g., CBF_PKT_1/CBF_PKT_N) does not affect packet decoding at the target non-AP STAs (STA1 and STA2) of sharing AP (AP1) and shared AP (AP2).

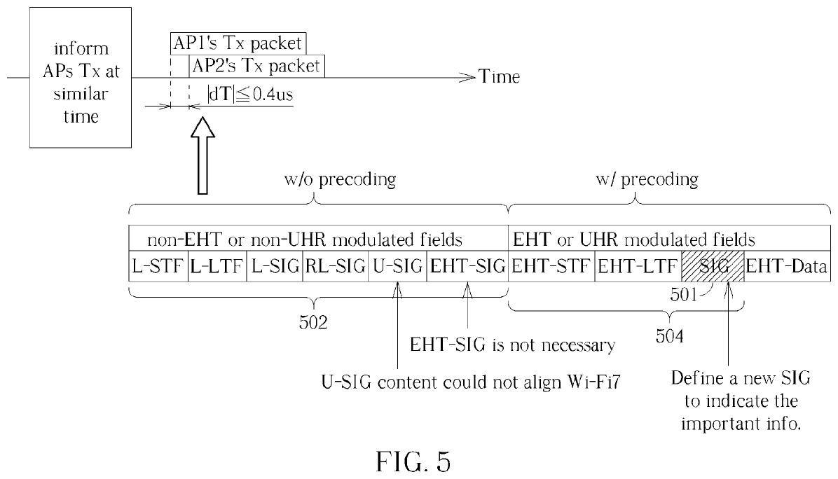

FIG. 5 is a diagram illustrating a second PHY design for CFB PPDU transmission with the timing error dT within +/−0.4 us according to an embodiment of the present invention. CBF PPDU timing synchronization is achieved through a CBF request frame that is generated from the sharing AP (AP1) and controls a starting time of the CBF PPDU (e.g., CBF PKT_1/CBF_PKT_N) generated from the shared AP (AP2). For example, the CBF PPDU (e.g., CBF_PKT_1/CBF_PKT_N) should be transmitted after SIFS of a PPDU carrying the CBF response frame (e.g., CBF_RSP_1/CBF_RSP_N) that is generated in response to the CBF request frame (e.g., CBF_REQ_0). In this embodiment, a new precoding-protected SIG field 501 is used to indicate the important information, including MCS, number of spatial streams (NSS), RU allocation, etc. The CBF PPDU (e.g., CBF_PKT_0) generated from the sharing AP (AP1) has a precoded preamble part 504 and an un-precoded preamble part 502, where SIG contents decided by the sharing AP (AP1) are recorded in the SIG field 501, and carried by the precoded preamble part 504. Similarly, the CBF PPDU (e.g., CBF_PKT_1/CBF_PKT_N) generated from the shared AP (AP2) also has a precoded preamble part 504 and an un-precoded preamble part 502, where SIG contents decided by the shared AP (AP2) are recorded in the SIG field 501, and carried by the precoded preamble part 504. Since SIG contents recorded in the SIG field 501 are precoding-protected, the preamble collision between API's CBF PPDU (e.g., CBF_PKT_0) and AP2's CBF PPDU (e.g., CBF_PKT_1/CBF_PKT_N) does not affect packet decoding at the target non-AP STAs (STA1 and STA2) of sharing AP (AP1) and shared AP (AP2).

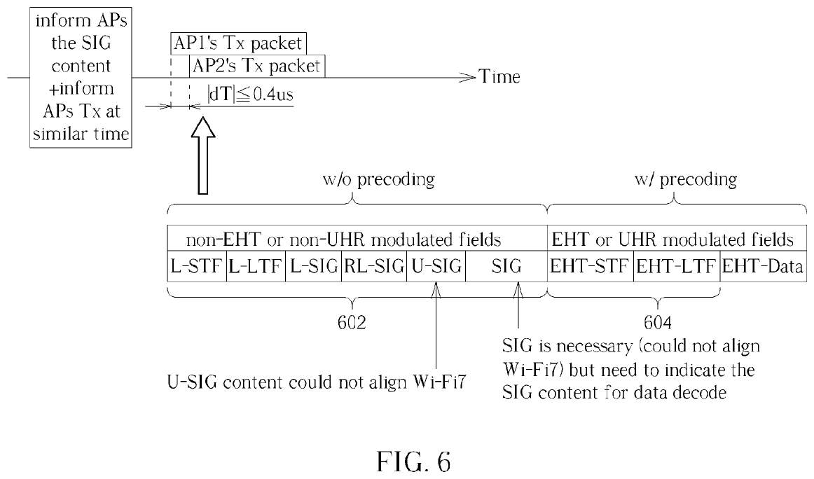

FIG. 6 is a diagram illustrating a third PHY design for CFB PPDU transmission with the timing error dT within +/−0.4 us according to an embodiment of the present invention. The same synchronized preamble SIG contents are confirmed by the sharing AP (AP1) and the shared AP (AP2) during the MAC frame exchange sequence, where the synchronized preamble SIG may be set by the sharing AP (AP1) or the shared AP (AP2). In addition, CBF PPDU timing synchronization is achieved through a CBF request frame (e.g., CBF_REQ_0) that is generated from the sharing AP (AP1) and controls a starting time of the CBF PPDU (e.g., CBF_PKT_1/CBF_PKT_N) generated from the shared AP (AP2). For example, the CBF PPDU (e.g., CBF_PKT_1/CBF_PKT_N) should be transmitted after SIFS of a PPDU carrying the CBF response frame (e.g., CBF_RSP_1/CBF_RSP_N) that is generated in response to the CBF request frame (e.g., CBF_REQ_0). In this embodiment, the CBF PPDU (e.g., CBF_PKT_0) generated from the sharing AP (AP1) has a precoded preamble part 604 and an un-precoded preamble part 602, where the synchronized preamble SIG contents are carried by the un-precoded preamble part 602. Similarly, the CBF PPDU (e.g., CBF_PKT_1/CBF_PKT_N) generated from the shared AP (AP2) also has a precoded preamble part 604 and an un-precoded preamble part 602, where the synchronized preamble SIG contents are carried by the un-precoded preamble part 602. The same synchronized preamble SIG contents are not precoding-protected in each of the CBF PPDU (e.g., CBF_PKT_0) generated from the sharing AP (AP1) and the CBF PPDU (e.g., CBF_PKT_1/CBF_PKT_N) generated from the shared AP (AP2). Since transmission of the synchronized preamble SIG contents carried by the CBF PPDU (e.g., CBF_PKT_1/CBF_PKT_N) generated from the shared AP (AP2) is synchronized with transmission of the same synchronized preamble SIG contents carried by the CBF PPDU (e.g., CBF_PKT_0) generated from the sharing AP (AP1), the preamble collision between API's CBF PPDU (e.g., CBF_PKT_0) and AP2's CBF PPDU (e.g., CBF_PKT_1/CBF_PKT_N) does not affect packet decoding at target non-AP STAs (STA1 and STA2) of sharing AP (AP) and shared AP (AP2).

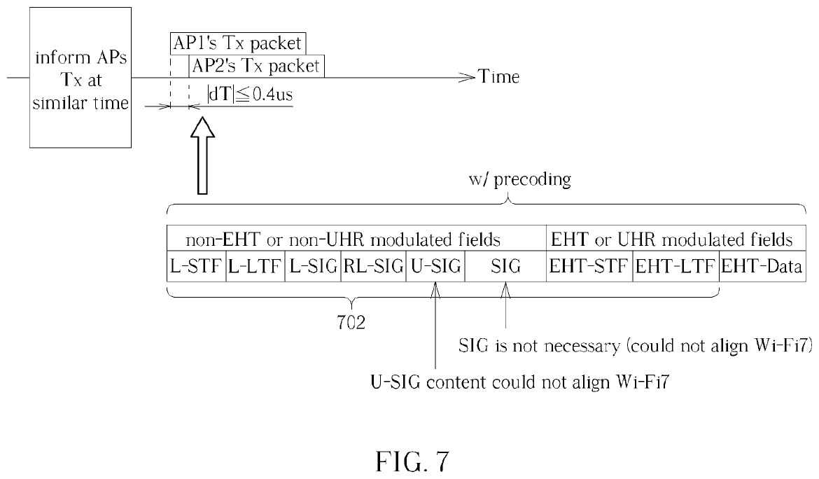

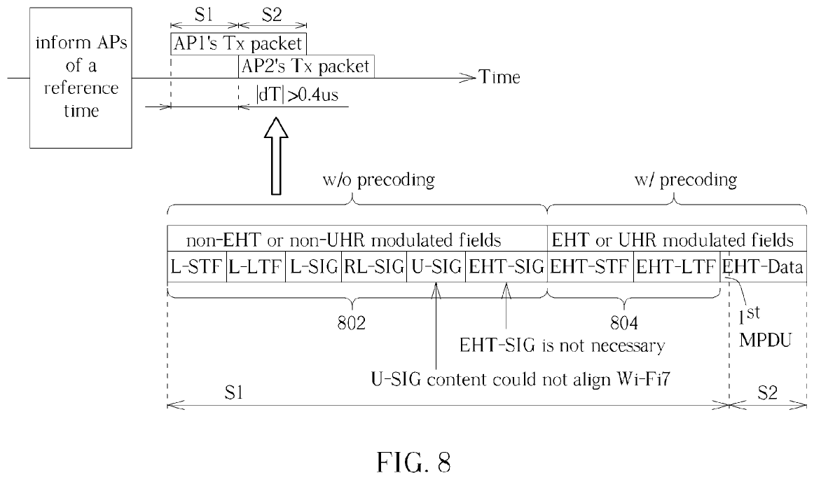

FIG. 7 is a diagram illustrating a fourth PHY design for CFB PPDU transmission with the timing error dT within +/−0.4 us according to an embodiment of the present invention. CBF PPDU timing synchronization is achieved through a CBF request frame (e.g., CBF_REQ_0) that is generated from the sharing AP (AP1) and controls a starting time of the CBF PPDU (e.g., CBF_PKT_1/CBF_PKT_N) generated from the shared AP (AP2). For example, the CBF PPDU (e.g., CBF_PKT_1/CBF_PKT_N) should be transmitted after SIFS of a PPDU carrying the CBF response frame (e.g., CBF_RSP_1/CBF_RSP_N) that is generated in response to the CBF request frame (e.g., CBF_REQ_0). In this embodiment, both of the sharing AP (AP1) and the shared AP (AP2) apply precoding to the whole preamble in one PPDU. Hence, the CBF PPDU (e.g., CBF_PKT_0) generated from the sharing AP (AP1) has a precoded preamble part 702 and has no un-precoded preamble part, and the CBF PPDU (e.g., CBF_PKT_1/CBF_PKT_N) generated from the shared AP (AP2) has a precoded preamble part 702 and has no un-precoded preamble part. Since all preamble SIG contents are precoding-protected, the preamble collision between API's CBF PPDU (e.g., CBF_PKT_0) and AP2's CBF PPDU (e.g., CBF_PKT_1/CBF_PKT_N) does not affect packet decoding at target non-AP STAs (STA1 and STA2) of sharing AP (AP1) and shared AP (AP2).
FIG. 8 is a diagram illustrating a first PHY design for CFB PPDU transmission with the timing error dT beyond +/−0.4 us according to an embodiment of the present invention. A starting time of a later AP's CBF PPDU is controlled by the sharing AP (AP1) during the MAC frame exchange sequence. For example, the CBF related information carried by the CBF request frame (e.g., CBF_REQ_0) generated from the sharing AP (AP1) is indicative of the starting time of the CBF PPDU (e.g., CBF_PKT_1/CBF_PKT_N) to be transmitted by the shared AP (AP2). In this embodiment, the CBF PPDU (e.g., CBF_PKT_0) generated from the sharing AP (AP1) has a precoded preamble part 804 and an un-precoded preamble part 802. Similarly, the CBF PPDU (e.g., CBF_PKT_1/CBF_PKT_N) generated from the shared AP (AP2) also has a precoded preamble part 804 and an un-precoded preamble part 802. The asynchronous transmission of API's CBF PPDU and AP2's CBF PPDU can protect a portion of API's CBF PPDU from being interfered with the AP2's CBF PPDU. For example, the starting time of the CBF PPDU (e.g., CBF_PKT_1/CBF_PKT_N) transmitted by the shared AP (AP2) is properly controlled to ensure that the preamble and the first MPDU of AP1's CBF PPDU are not interfered with AP2's CBF PPDU. As shown in FIG. 8, the CBF PPDU (e.g., CBF_PPDU_0) transmitted from the sharing AP (AP1) includes a first segment S1 and a second segment S2 following the first segment S1, a period in which the first segment S1 is transmitted does not overlap a period in which the CBF PPDU (e.g., CBF_PPDU_1/CBF_PPDU_N) is transmitted by the shared AP (AP2), a period in which the second segment S2 is transmitted overlaps the period in which the CBF PPDU (e.g., CBF_PPDU_1/CBF_PPDU_N) is transmitted by the shared AP (AP2), and a preamble and a first MPDU are carried by the first segment S1. If decoding of the first MPDU included in the CBF PPDU (e.g., CBF_PPDU_0) transmitted from the sharing AP (AP1) is interfered with the CBF PPDU (e.g., CBF_PPDU_1/CBF_PPDU_N) is transmitted by the shared AP (AP2), an RX circuit of the non-AP STA (STA1) may erroneously switch from receiving AP1's CBF PPDU to receiving AP2's CBF PPDU. To address this issue, the present invention proposes controlling the starting time of AP2's CBF PPDU to ensure that decoding of the first MPDU included in API's CBF PPDU is protected from being interfered with AP2's CBF PPDU.

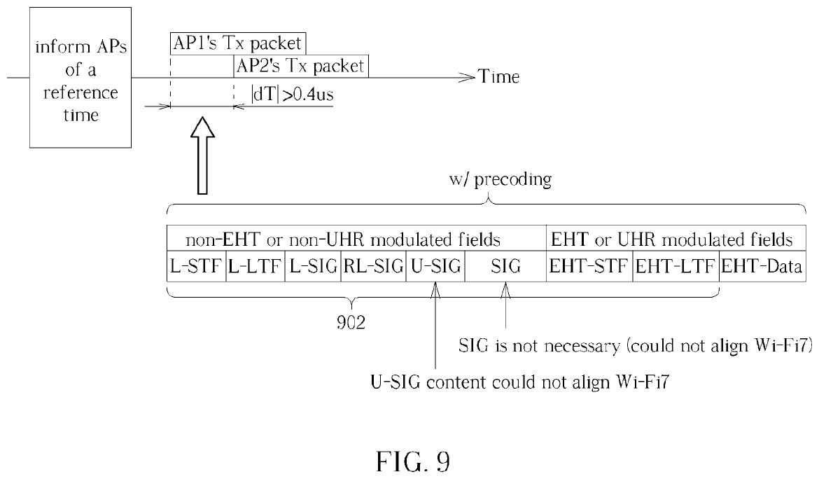

FIG. 9 is a diagram illustrating a second PHY design for CFB PPDU transmission with the timing error dT beyond +/−0.4 us according to an embodiment of the present invention. A starting time of a later AP's CBF PPDU is controlled by the sharing AP (AP1) during the MAC frame exchange sequence. For example, the CBF related information carried by the CBF request frame (e.g., CBF_REQ_0) generated from the sharing AP (AP1) is indicative of the starting time of the CBF PPDU (e.g., CBF_PKT_1/CBF_PKT_N) to be transmitted by the shared AP (AP2). In this embodiment, the CBF PPDU (e.g., CBF_PKT_0) generated from the sharing AP (AP1) has a precoded preamble part 804 and an un-precoded preamble part 802. Similarly, the CBF PPDU (e.g., CBF_PKT_1/CBF_PKT_N) generated from the shared AP (AP2) also has a precoded preamble part 804 and an un-precoded preamble part 802. Regarding asynchronous transmission of API's CBF PPDU and AP2's CBF PPDU, both of the sharing AP (AP1) and the shared AP (AP2) apply precoding to the whole preamble in one PPDU. Hence, the CBF PPDU (e.g., CBF_PKT_0) generated from the sharing AP (AP1) has a precoded preamble part 902 and has no un-precoded preamble part, and the CBF PPDU (e.g., CBF_PKT_1/CBF_PKT_N) generated from the shared AP (AP2) has a precoded preamble part 902 and has no un-precoded preamble part. Since all preamble SIG contents are precoding-protected, preamble collision between AP1's CBF PPDU (e.g., CBF_PKT_0) and AP2's CBF PPDU (e.g., CBF_PKT_1/CBF_PKT_N) does not affect packet decoding at target non-AP STAs (STA1 and STA2) of sharing AP (AP1) and shared AP (AP2).

It should be noted that the PPDU formats shown in FIGS. 4-9 are for illustrative purposes only, and are not meant to be limitations of the present invention. In practice, the PPDU format may be adjusted, depending upon the Wi-Fi specification.

In above embodiments, the proposed MAC frame exchange sequence and PHY designs are illustrated under an SU scenario. However, this is for illustrative purposes only, and is not meant to be a limitation of the present invention. The same preamble collision reduction concept is applicable to an MU scenario.

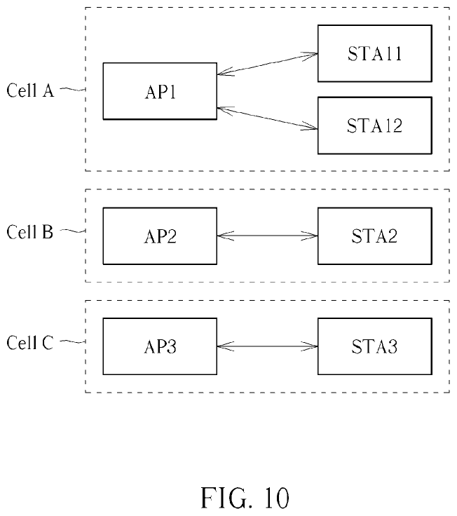

FIG. 10 is a diagram illustrating a CBF topology under an MU scenario according to an embodiment of the present invention. Multiple non-AP STAs (labeled by “STA11” and “STA12”) are associated to one AP (labeled by “AP1”) in one cell (labeled by “Cell A”), one non-AP STA (labeled by “STA2”) is associated to another AP (labeled by “AP2”) in another cell (labeled by “Cell B”), and one non-AP STA (labeled by “STA3”) is associated to yet another AP (labeled by “AP3”) in yet another cell (labeled by “Cell C”). In this embodiment, multiple APs (AP2 & AP3) join the CBF AP group; and the sharing AP (AP1) transmits an MU PPDU to multiple non-AP STAs (STA11 & STA 12), and transmits a CBF request frame to multiple shared APs (AP2 & AP3). Alternatively, more than one non-AP STA may be associated to the shared AP (AP2), and/or more than one non-AP STA may be associated to the shared AP (AP3). Hence, the shared AP (AP2) may transmit an MU PPDU to multiple non-AP STAs, and/or the shared AP (AP3) may transmit an MU PPDU to multiple non-AP STAs.

The sharing AP (AP1) may be the AP 102 shown in FIG. 1, and the shared APs (AP2 &AP3) may be APs 104_1 and 104_N shown in FIG. 1. During a MAC frame exchange sequence, the control circuit 116 of the AP (e.g., sharing AP) 102 is arranged to generate a CBF request frame CBF_REQ_0 used to carry CBF related information, and instruct the network interface circuit 117 (particularly, TX circuit 118 of network interface circuit 117) to transmit the CBF request frame CBF_REQ_0 to multiple APs (e.g., shared APs) 104_1, 104_N of the MAP system 100 before CBF PPDU transmission of the sharing AP and shared APs. For example, the CBF related information carried by the CBF request frame CBF_REQ_0 may be indicative of synchronized preamble SIG contents shared by APs 102, 104_1, 104_N, starting time information of CBF PPDUs to be transmitted by APs 104_1, 104_N, allowed bandwidths of CBF PPDUs to be transmitted by APs 104_1, 104_N, IDs of target non-AP STAs (STA11 & STA12) of AP 102, preferred non-AP STA candidates associated to APs 104_1, 104_N, a length of a CBF PPDU to be transmitted by AP 102, ending time of a CBF PPDU to be transmitted by AP 102, and/or beam change setting included in a CBF PPDU to be transmitted by AP 102.

During the MAC frame exchange sequence, the control circuit 126_1 of the AP (e.g., shared AP) 104_1 is arranged to generate a CBF response frame CBF_RSP_1 used to carry CBF related information, and instruct the network interface circuit 127_1 (particularly, TX circuit 128_1 of network interface circuit 127_1) to transmit the CBF response frame CBF_RSP_1 to the AP (e.g., sharing AP) 102 before CBF PPDU transmission of the sharing AP and shared APs, and the control circuit 126_N of the AP (e.g., shared AP) 104_N is arranged to generate a CBF response frame CBF RSP_N used to carry CBF related information, and instruct the network interface circuit 127_N (particularly, TX circuit 128_N of network interface circuit 127_N) to transmit the CBF response frame CBF_RSP_N to the AP (e.g., sharing AP) 102 before CBF PPDU transmission of the sharing AP and shared AP(s). For example, the CBF related information carried by the CBF response frame CBF_RSP_1 may be indicative of whether a CBF request of AP 102 is rejected or accepted, synchronized preamble SIG contents that are decided by AP 104_1, a bandwidth of a CBF PPDU to be transmitted by AP 104_1 if partial bandwidth can be used, and/or ID(s) of target non-AP STA(s) of AP 104_1; and the CBF related information carried by the CBF response frame CBF_RSP_N may be indicative of whether a CBF request of AP 102 is rejected or accepted, synchronized preamble SIG contents that are decided by AP 104_N, a bandwidth of a CBF PPDU to be transmitted by AP 104_N if partial bandwidth can be used, and/or ID(s) of target non-AP STA(s) of AP 104_N.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A first access point (AP) of a multi-AP (MAP) system comprising:
a network interface circuit; and
a control circuit, arranged to generate a first coordinated beamforming (CBF) physical layer protocol data unit (PPDU) with a precoded preamble part and an un-precoded preamble part, and instruct the network interface circuit to transmit the first CBF PPDU after at least one non-AP station (STA) associated to the first AP and at least one non-AP STA associated to at least one second AP of the MAP system are informed of synchronized preamble signal (SIG) contents.

2. The first AP of claim 1, wherein a timing error between a starting time of the first CBF PPDU transmitted by the first AP and a starting time of a second CBF PPDU transmitted by the at least one second AP is within a pre-defined timing error tolerance.

3. A first access point (AP) of a multi-AP (MAP) system comprising:
a network interface circuit; and
a control circuit, arranged to generate a first coordinated beamforming (CBF) physical layer protocol data unit (PPDU) with a precoded preamble part and an un-precoded preamble part, and instruct the network interface circuit to transmit the first CBF PPDU, wherein a preamble signal (SIG) content is carried by the precoded preamble part.

4. The first AP of claim 3, wherein a timing error between a starting time of the first CBF PPDU transmitted by the first AP and a starting time of a second CBF PPDU transmitted by at least one second AP of the MAP system is within a pre-defined timing error tolerance.

5. A first access point (AP) of a multi-AP (MAP) system comprising:
a network interface circuit; and
a control circuit, arranged to generate a first coordinated beamforming (CBF) physical layer protocol data unit (PPDU) with a precoded preamble part and an un-precoded preamble part, and instruct the network interface circuit to transmit the first CBF PPDU after synchronized preamble signal (SIG) contents are confirmed by the first AP and at least one second AP of the MAP system, wherein the same synchronized SIG contents are carried by each of the un-precoded part of the first CBF PPDU and an un-precoded part of a second CBF PPDU transmitted by the at least one second AP.

6. The first AP of claim 5, wherein a timing error between a starting time of the first CBF PPDU transmitted by the first AP and a starting time of the second CBF PPDU transmitted by the at least one second AP is within a pre-defined timing error tolerance.

7. A first access point (AP) of a multi-AP (MAP) system comprising:
a network interface circuit; and
a control circuit, arranged to generate a first coordinated beamforming (CBF) physical layer protocol data unit (PPDU) with a precoded preamble part and without an un-precoded preamble part, and instruct the network interface circuit to transmit the first CBF PPDU.

8. The first AP of claim 7, wherein a timing error between a starting time of the first CBF PPDU transmitted by the first AP and a starting time of a second CBF PPDU transmitted by at least one second AP of the MAP system is within a pre-defined timing error tolerance.

9. The first AP of claim 1, wherein a timing error between a starting time of the first CBF PPDU transmitted by the first AP and a starting time of a second CBF PPDU transmitted by at least one second AP of the MAP system is beyond a pre-defined timing error tolerance.

10. A first access point (AP) of a multi-AP (MAP) system comprising:
a network interface circuit; and
a control circuit, arranged to generate a first coordinated beamforming (CBF) physical layer protocol data unit (PPDU) with a precoded preamble part and an un-precoded preamble part, and instruct the network interface circuit to transmit the first CBF PPDU, wherein a timing error between a starting time of the first CBF PPDU transmitted by the first AP and a starting time of a second CBF PPDU transmitted by a second AP of the MAP system is beyond a pre-defined timing error tolerance.

11. The first AP of claim 10, wherein the second CBF PPDU includes a first segment and a second segment following the first segment, a period in which the first segment is transmitted does not overlap a period in which the first CBF PPDU is transmitted, a period in which the second segment is transmitted overlaps the period in which the first CBF PPDU is transmitted, and a preamble and a first medium access control protocol data unit (MPDU) are carried by the first segment.
